(19) United States
(12) Patent Application Publication
(10) Pub. No.: US 2025/0329507 A1
(43) Pub. Date: Oct. 23, 2025

(54) PADDLE-STYLE HANDSET CONTROL AND HEIGHT ADJUSTABLE DESK

(71) Applicant: ZHEJIANG JIECANG LINEAR MOTION TECHNOLOGY CO., LTD., Shaoxing (CN)

(72) Inventor: Kun LIN, Shaoxing (CN)

(73) Assignee: ZHEJIANG JIECANG LINEAR MOTION TECHNOLOGY CO., LTD., Shaoxing (CN)

(21) Appl. No.: 19/259,896

(22) Filed: Jul. 3, 2025

Related U.S. Application Data
(63) Continuation of application No. PCT/CN2024/073794, filed on Jan. 24, 2024.

(30) Foreign Application Priority Data
Mar. 9, 2023 (CN) 202310252029.8

(51) Int. Cl. H01H 23/28; A47B 9/00

(52) U.S. Cl. CPC H01H 23/28; A47B 9/00

(57) ABSTRACT

A paddle-style handset control and a height adjustable desk; the paddle-style handset control includes a bracket and paddle piece mounted on the bracket, the paddle piece including a horizontal connecting section in the bracket and a manipulating section extending out of the bracket; the paddle-style handset control further includes a two-way switch including a switch body installed on the paddle piece and a rocker, the switch body includes up and down contactors; the rocker is provided thereon with a rotating shaft, one end of the rocker being connected to the switch body via the rotating shaft, another end restrained on the bracket; the paddle piece tilts driving the rocker to rock relative to the switch body thereby triggering the up or down contactors. In the paddle-style handset control, the two-way switch as an integrated structure is mounted on the paddle piece, which facilitates assembly of the paddle-style handset control.

### FIELD

The subject matter described herein relates to a technology for height adjustable desks, and more particularly relates to a paddle-style handset control and a height adjustable desk.

### BACKGROUND

Smart furniture is becoming increasingly popular with improvement of people's living standards. The smart furniture is usually driven by an automatic lifting platform. The automatic lifting platform is generally actuated by an electric motor and adjusted via a mechanical mechanism under control of a control device. An up switch and a down switch are configured on the control device to enable smooth height adjustment of the lifting platform. An adjustment principle followed thereby goes like this: when the up switch is activated, a microcontroller on a circuit board in the control device issues an “up” command to the control device, so that the control device controls the electric motor to rotate clockwise, driving the mechanical mechanism to perform an “up” movement; when the down switch is activated, the microcontroller on the circuit board in the control device issues a “down” command to the control device, so that the control device controls the electric motor to rotate counterclockwise, driving the mechanical mechanism to perform a “down” movement.

A paddle-style handset control is a control device commonly applied to height adjustable desks. The paddle-style handset control allows for an operator to conveniently control a desk to stop at any desired height during a desk lifting process. An existing paddle-style handset control usually adopts two discrete switches for controlling up/down movement of the desk, respectively; however, it is a laborious task to separately install and position the two switches to the paddle-style handset control.

### SUMMARY

A paddle-style handset control is provided, which is more convenient to assemble owing to employment of an integrated two-way switch on a paddle piece and thusly overcomes a drawback of an existing paddle-style handset control that is laborious in mounting and positioning thereon two discrete switches for separately controlling up and down movement of a height adjustable desk.

This disclosure adopts a technical solution set forth infra:

A paddle-style handset control, comprising a bracket and a paddle piece rotatably mounted on the bracket, the paddle piece comprising a horizontal connecting section disposed in the bracket and a manipulating section extending inclinedly downwardly out of the bracket, wherein the paddle-style handset control further comprises a two-way switch, the two-way switch comprising a switch body and a rocker, the switch body being installed on the paddle piece; the switch body comprises an up contactor and a down contactor; the rocker is provided thereon with a rotating shaft, one end of the rocker being rotatably connected to the switch body via the rotating shaft, another end thereof being restrained on the bracket; the paddle piece is tilted driving the rocker to rock relative to the switch body to thereby trigger the up contactor or the down contactor.

In the technical solution described supra, the paddle-style handset control is mounted on a height adjustable desk for controlling up/down movement of the latter. By mounting the paddle piece rotatably on the bracket and restraining one end of the rocker on the bracket, when the paddle piece is tilted, the rocker is driven to rock relative to the switch body to thereby trigger the up contactor or the down contactor, a signal being produced and transmitted to a circuit board, actuating up/down movement of the height adjustable desk. In this solution, the rocker, the up contactor, and the down contactor are set as an integral structure rather than discrete pieces, so that the switch body is mounted as a whole piece on the paddle piece, which facilitates assembly of the paddle-piece handset control. In addition, the simple manner of restraining (e.g., direct fixing) said another end of the rocker on the bracket eliminates a complex connection structure between the rocker and the bracket; moreover, the switch body and the paddle piece are also simply fixed together. That is to say, the two-way switch as a whole only relies on two simple connection structures to be mounted to the external structure. Such a connection manner is not only simple and reliable, but also lowers assembly difficulty. Rotatable connection of the rocker to the switch body via the rotating shaft prevents the rocker from being displaced relative to the switch body, so that when the rocker rocks relative to the switch body, only relative rotation occurs between the rocker and the switch body. In addition, by disposing two cantilevers at two opposite sides of the rotating shaft, it may ensure that the two cantilevers will not offset from the position of the rocker, so that the cantilevers can be always aligned to the up contactor and the down contactor without slipping or being accidentally displaced, which produces a satisfactory tactile sensation when the paddle-style handset control is tilted.

In some implementations, the up contactor and the down contactor are disposed at two opposite sides of the rocker; and a first cantilever and a second cantilever are secured at the end of the rocker connected to the switch body, the first cantilever and the second cantilever being arranged at two opposite sides of the rocker in such a manner that the first cantilever is disposed corresponding to the up contactor, the second cantilever is disposed corresponding to the down contactor.

In the technical solution noted supra, the first cantilever and the second cantilever may trigger the up contactor and the down contactor, respectively; by setting the first cantilever to correspond to the up contactor, setting the second cantilever to correspond to the down contactor, and disposing the first cantilever and the second cantilever at two opposite sides of the rocker, the tactile sensation from tilting the paddle piece in the two tilt directions is more consistent, which improves user experience.

In some implementations, the switch body further comprises a housing; the up contactor comprises a first movable contact and a first stationary contact; the down contactor comprises a second movable contact and a second stationary contact; the first stationary contact and the second stationary contact are both secured to the housing; the first cantilever drives the first movable contact to move so that the first movable contact contacts the first stationary contact; and the second cantilever drives the second movable contact to move so that the second movable contact contacts the second stationary contact.

In the technical solution described supra, when the paddle piece is tilted up driving the rocker to rock relative to the switch body, the first cantilever drives the first movable contact to move so that the first movable contact contacts the first stationary contact, which conducts the electric circuit, with a signal being produced and transmitted to a circuit board, actuating the height adjustable desk to move up, during which process, the second cantilever does not interact with the second movable contact. When the paddle piece is released, the first cantilever and the first movable contact return to their initial positions; now, the electric circuit is interrupted, the signal is interrupted, and the height adjustable desk stops movement. When the paddle piece is titled down driving the rocker to rock relative to the switch body, the second cantilever drives the second movable contact to move so that the second movable contact contacts the second stationary contact, which conducts the electric circuit, with a signal being produced and transmitted to the circuit board, actuating the height adjustable desk to move down, during which process, the first cantilever does not interact with the first movable contact. When the paddle piece is released, the second cantilever and the second movable contact return to their initial positions; now, the electric circuit is interrupted, the signal is interrupted, and the height adjustable desk stops movement. With this solution, when the paddle piece is tilted up, the height adjustable desk moves up; and when the paddle piece is tilted down, the height adjustable desk moves down.

In some implementations, the up contactor further comprises a third stationary contact, and the down contactor further comprises a fourth stationary contact; the first movable contact is disposed between the first stationary contact and the third stationary contact, and the second movable contact is disposed between the second stationary contact and the fourth stationary contact; and when the paddle piece is tilted and then released, the first movable contact returns to hit the third stationary contact with a sound produced, or the second movable contact returns to hit the fourth stationary contact with a sound produced.

In the technical solution noted supra, the collision sound produced when the first movable contact or the second movable contact returns plays a role of alerting, which improves user experience.

In some implementations, the first movable contact and the first stationary contact are laminated in a thickness direction of the paddle piece, and the second movable contact and the second stationary contact are laminated in the thickness direction of the paddle piece.

In the technical solution noted supra, the thickness direction is parallel to a rotating plane of the paddle piece, which may reduce thickness of the paddle-style handset control, resulting in a light and thin profile of the paddle-style handset control.

In some implementations, the up contactor further comprises a first spring plate, one end of the first spring plate being secured to the housing and another end thereof being free, the first movable contact being disposed at the free end of the first spring plate, the first cantilever abutting tightly against the first spring plate; the down contactor further comprises a second spring plate, one end of the second spring plate being secured to the housing and another end thereof being free, the second movable contact being disposed at the free end of the second spring plate, the second cantilever abutting tightly against the second spring plate.

In the technical solution described supra, when the paddle piece is released, the first spring plate and the second spring plate provide a return force due to their elastic characteristics. When the paddle piece is tilted up so that the rocker rocks relative to the two-way switch, the first cantilever compresses the first spring plate, the first spring plate being deformed under compression driving the free end of the first spring plate to move closer to the first stationary contact; with enough force imposed on the paddle piece, the free end of the first spring plate contacts the first stationary contact; now, the electric circuit is conducted, with a signal being produced and transmitted to the circuit board, actuating the height adjustable desk to move up, during which process, the second spring plate does not interact with the second cantilever; when the paddle piece is released, the inherent elasticity of the first spring plate drives the paddle piece to return to its initial position; now, the electric circuit is interrupted, the signal is interrupted, and the height adjustable desk stops movement. When the paddle piece is tilted down so that the rocker rocks relative to the two-way switch, the second cantilever compresses the second spring plate, the second spring plate being deformed under compression driving the free end of the second spring plate to move closer to the second stationary contact; with enough force imposed on the paddle piece, the free end of the second spring plate contacts the second stationary contact; now, the electric circuit is conducted, with a signal being produced and transmitted to the circuit board, actuating the height adjustable desk to move down, during which process, the first spring plate does not interact with the first cantilever; when the paddle piece is released, the inherent elasticity of the second spring plate drives the paddle piece to return to its initial position; now, the electric circuit is interrupted, the signal is interrupted, and the height adjustable desk stops movement. In the technical solution described supra, the first spring plate and the second spring plate, the first stationary contact and the second stationary contact, and the first cantilever and the second cantilever are all disposed at two opposite sides of the rocker, respectively, such that the up/down tilt torques of the paddle piece are substantially identical, which produces substantially consistent tactile and audio feedbacks for each contactor. Therefore, when the paddle-style handset control according to this disclosure is tilted, the tactile and audio feedbacks may maintain highly consistent, offering an improved manipulation experience.

In some implementations, the switch body further comprises a holder; and the first spring plate comprises a spring plate body and a reset tab, the spring plate body comprising a fixed end connected to the holder and a free end where the first movable contact is disposed, the reset tab being disposed between the free end and the fixed end of the spring plate body, one end of the reset tab being secured to the spring plate body, another end of the reset tab being positioned on the holder, the reset tab being bent in a direction opposite a deformation direction of the spring plate body, the first cantilever being disposed between the fixed end of the spring plate body and the reset tab.

In the technical solution noted supra, the deformation direction of the spring plate body refers to the bent direction of the spring plate body when being compressed by the first cantilever. The elastic force of the first spring plate is jointly contributed by the spring plate body and the reset tab; the reset tab bent in a direction opposite the deformation direction of the spring plate body may provide an elastic force contrary to the deformation direction of the spring plate body to thereby increase the overall elastic force of the first spring plate. In the initial stage of the first cantilever compressing the spring plate body, the restoring force provided by the reset tab may reduce the elastic deformation of the free end of the spring plate body, giving a greater elastic support force to the first spring plate, which helps retain a persistent elastic support to the first spring plate to thereby extend the service life of the first spring plate. When the first cantilever compresses the spring plate body to an extent exceeding a threshold value, the first spring plate is quickly deformed to hit the first stationary contact, with a collision sound produced.

In some implementations, the fixed end of the spring plate body and said another end of the reset tab co-act to clamp the holder tightly so that the one end of the first spring plate is detachably connected to the holder. In the technical solution described supra, the reset tab may leverage its own elastic force to co-act with the spring plate body to clamp the holder tightly, thereby achieving a detachable, stable, and easily installable secure connection between the first spring plate and the holder. The reset tab may not only provide an elastic force driving return of the first spring plate, but also may leverage its own elastic force to secure the first spring plate to the holder.

In some implementations, a rotating axis of the rocker relative to the switch body and a rotating axis of the paddle piece relative to the bracket are located in a same vertical plane.

In some implementations, a limiting slot is arranged on the bracket; the paddle piece comprises a handle and a limiting member secured to the handle, one end of the limiting member projecting into the limiting slot so that the limiting member is rotatable in the limiting slot relative to the holder. This structure plays a role of positioning during assembly, which facilitates quick assembly; in addition, after the assembly is completed, a rotational connection structure is created so that the paddle piece can rotate relative to the bracket.

A height adjustable desk comprises a desktop support and a desktop board mounted on the desktop support, wherein the height adjustable desk further comprises a paddle-style handset control described supra, a bracket of the paddle-style handset control being secured to the desktop board.

### BRIEF DESCRIPTION OF THE DRAWINGS

FIG. 1 is a first structural diagram of this disclosure;

FIG. 2 is a sectional view of this disclosure;

FIG. 3 is a first structural view of a two-way switch according to this disclosure;

FIG. 4 is a second structural view of this disclosure;

FIG. 5 is a second structural view of a two-way switch according to this disclosure.

In the drawings: 1—bracket; 1.1—limiting slot; 1.2—base; 1.3—cover plate; 1.4—first cable hole; 2—paddle piece; 2.1—handle; 2.1.1—horizontal connecting section; 2.1.2—manipulating section; 2.2—limiting member; 2.3—second cable hole; 3—two-way switch; 3.0—switch body; 3.1.1—first spring plate; 3.1.1.0—spring plate body; 3.1.2—second spring plate; 3.2—first stationary contact; 3.3—housing; 3.4—second stationary contact; 3.5—holder; 3.6—engaging slot; 3.7—through hole; 3.8—reset tab; 3.11—up contactor; 3.12—down contactor; 3.13—first movable contact; 3.14—second movable contact; 3.15—third stationary contact; 3.16—fourth stationary contact; 4—rocker; 6.1—first cantilever; 6.2—second cantilever; 7—rotating shaft; 8—circuit board.

### DETAILED DESCRIPTION OF EMBODIMENTS

Hereinafter, this disclosure will be described in further detail through example implementations with reference to the accompanying drawings.

### First Implementation

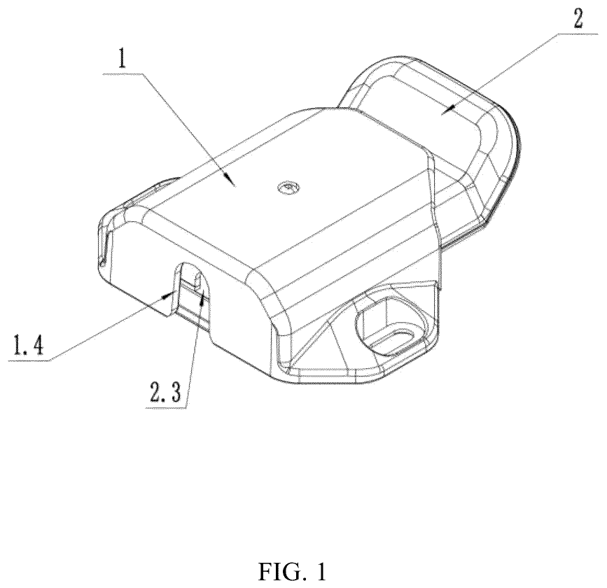

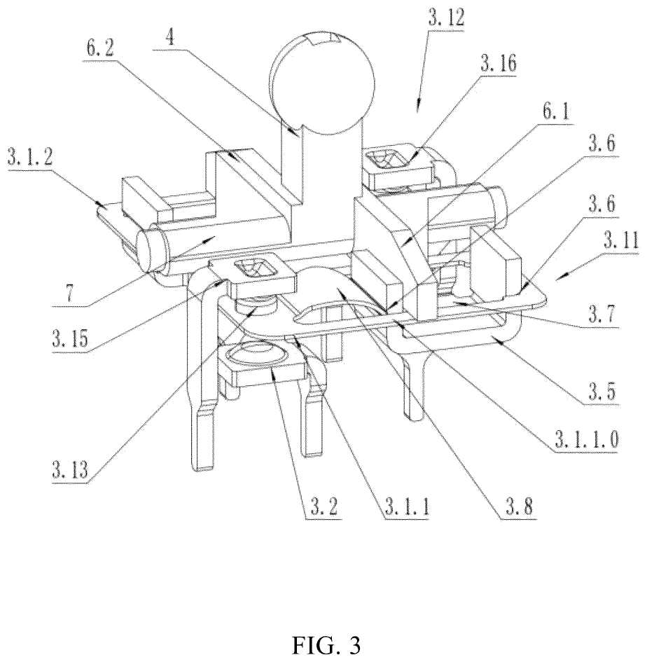

As illustrated in FIGS. 1 to 4, a paddle-style handset control comprises a bracket 1 and a paddle piece 2 rotatably mounted on the bracket 1, the paddle piece 2 comprising a horizontal connecting section 2.1.1 arranged in the bracket 1 and a manipulating section 2.1.2 extending inclinedly downwardly out of the bracket; the paddle-style handset control further comprises a two-way switch 3, the two-way switch 3 comprising a switch body 3.0 and a rocker 4, the switch body 3.0 being mounted on the paddle piece 2, the switch body 3.0 comprising an up contactor 3.11 and a down contactor 3.12; a rotating shaft 7 is securely provided on the rocker 4, one end of the rocker 4 being rotatably connected to the switch body 3.0 via the rotating shaft 7, another end thereof being restrained on the bracket 1; by tilting the paddle piece 2, the rocker 4 is driven to rock relative to the switch body 3.0, whereby the up contactor 3.11 or the down contactor 3.12 is triggered.

In the technical solution described supra, the paddle-style handset control is mounted on a height adjustable desk for controlling up/down movement of the latter. By mounting the paddle piece 2 rotatably on the bracket 1 and restraining one end of the rocker 4 on the bracket 1, when the paddle piece 2 is tilted, the rocker 4 is driven to rock relative to the switch body 3.0 to thereby trigger the up contactor 3.11 or the down contactor 3.12, a signal being produced and transmitted to a circuit board 8, actuating up/down movement of the height adjustable desk. In this solution, the rocker 4, the up contactor 3.11, and the down contactor 3.12 are set as an integral structure rather than discrete pieces, so that the switch body 3.0 is mounted as a whole piece on the paddle piece 2, which facilitates assembly of the paddle-piece handset control. In addition, the simple manner of restraining (e.g., direct fixing) said another end of the rocker 4 on the bracket 1 eliminates a complex connection structure between the rocker 4 and the bracket 1; moreover, the switch body 3.0 and the paddle piece 2 are also simply fixed together. That is to say, the two-way switch 3 as a whole only relies on two simple connection structures to be mounted to the external structure. Such a connection manner is not only simple and reliable, but also lowers assembly difficulty. Rotatable connection of the rocker 4 to the switch body 3.0 via the rotating shaft 7 prevents the rocker 4 from being displaced relative to the switch body 3.0, so that when the rocker 4 rocks relative to the switch body 3.0, only relative rotation occurs between the rocker 4 and the switch body 3.0. In addition, by disposing two cantilevers at two opposite sides of the rotating shaft 7, it may ensure that the two cantilevers will not offset from the position of the rocker 4, so that the cantilevers can be always aligned to the up contactor 3.11 or the down contactor 3.12 without slipping or being accidentally displaced, which produces a satisfactory tactile sensation when the paddle-style handset control is tilted.

The up contactor 3.11 and the down contactor 3.12 are disposed at two opposite sides of the rocker 4; and a first cantilever 6.1 and a second cantilever 6.2 are fixedly provided at the end of the rocker 4 connected to the switch body 3.0, the first cantilever 6.1 and the second cantilever 6.2 being arranged at two opposite sides of the rocker 4 in such a manner that the first cantilever 6.1 is disposed corresponding to the up contactor 3.11, the second cantilever 6.2 is disposed corresponding to the down contactor 3.12.

In the technical solution described supra, the first cantilever 6.1 and the second cantilever 6.2 are configurable to trigger the up contactor 3.11 and the down contactor 3.12, respectively. By setting the first cantilever 6.1 to correspond to the up contactor 3.11, setting the second cantilever 6.2 to correspond to the down contactor 3.12, and disposing the first cantilever 6.1 and the second cantilever 6.2 at two opposite sides of the rocker 4, more consistent tactile sensation can be obtained when tilting the paddle piece 2 in both directions, which improves user experience.

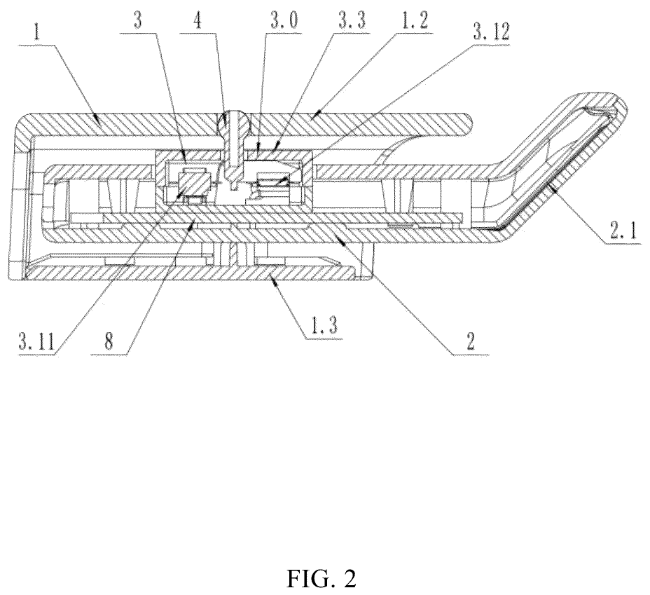

As illustrated in FIGS. 2, 3, and 5, the switch body 3.0 further comprises a housing 3.3; the up contactor 3.11 comprises a first movable contact 3.13 and a first stationary contact 3.2; the down contactor 3.12 comprises a second movable contact 3.14 and a second stationary contact 3.4, the first stationary contact 3.2 and the second stationary contact 3.4 being both secured to the housing 3.3; the first cantilever 6.1 drives the first movable contact 3.13 to move so that the first movable contact 3.13 contacts the first stationary contact 3.2, and the second cantilever 6.2 drives the second movable contact 3.14 to move so that the second movable contact 3.14 contacts the second stationary contact 3.4.

In the technical solution described supra, when the paddle piece 2 is tilted up driving the rocker 4 to rock relative to the switch body 3.0, the first cantilever 6.1 drives the first movable contact 3.13 to move so that the first movable contact 3.13 contacts the first stationary contact 3.2, which conducts the electric circuit, with a signal being produced and transmitted to a circuit board 8, actuating the height adjustable desk to move up; during which process, the second cantilever 6.2 does not interact with the second movable contact 3.14. When the paddle piece 2 is released, the first cantilever 6.1 and the first movable contact 3.13 return to their initial positions; now, the electric circuit is interrupted, the signal is interrupted, and the height adjustable desk stops movement. When the paddle piece 2 is titled down driving the rocker 4 to rock relative to the switch body 3.0, the second cantilever 6.2 drives the second movable contact 3.14 to move so that the second movable contact 3.14 contacts the second stationary contact 3.4, which conducts the electric circuit, with a signal being produced and transmitted to the circuit board 8, actuating the height adjustable desk to move down, during which process, the first cantilever 6.1 does not interact with the first movable contact 3.13. When the paddle piece 2 is released, the second cantilever 6.2 and the second movable contact 3.14 return to their initial positions; now, the electric circuit is interrupted, the signal is interrupted, and the height adjustable desk stops movement. With this solution, when the paddle piece 2 is tilted up, the height adjustable desk moves up; and when the paddle piece 2 is tilted down, the height adjustable desk moves down.

Specifically, the up contactor 3.11 further comprises a first spring plate 3.1.1, one end of the first spring plate 3.1.1 being secured to the housing 3.3, another end thereof being free, the first movable contact 3.13 being disposed at the free end of the first spring plate 3.1.1, the first cantilever 6.1 abutting tightly against the first spring plate 3.1.1; the down contactor 3.12 further comprises a second spring plate 3.1.2, one end of the second spring plate 3.1.2 being secured to the housing 3.3, another end thereof being free, the second movable contact 3.14 being disposed at the free end of the second spring plate 3.1.2, the second cantilever 6.2 abutting against the second spring plate 3.1.2.

In the technical solution described supra, when the paddle piece 2 is released, the first spring plate 3.1.1 and the second spring plate 3.1.2 provide a return force due to their elastic characteristics. When the paddle piece 2 is tilted up so that the rocker 4 rocks relative to the two-way switch 3, the first cantilever 6.1 compresses the first spring plate 3.1.1, the first spring plate 3.1.1 being deformed under compression driving the free end of the first spring plate 3.1.1 to move closer to the first stationary contact 3.2; with enough force imposed on the paddle piece 2, the free end of the first spring plate 3.1.1 contacts the first stationary contact 3.2; now, the electric circuit is conducted, with a signal being produced and transmitted to the circuit board 8, actuating the height adjustable desk to move up, during which process, the second spring plate 3.1.2 does not interact with the second cantilever 6.2; when the paddle piece 2 is released, the inherent elasticity of the first spring plate 3.1.1 drives the paddle piece 2 to return to its initial position; now, the electric circuit is interrupted, the signal is interrupted, and the height adjustable desk stops movement. When the paddle piece 2 is tilted down so that the rocker 4 rocks relative to the two-way switch 3, the second cantilever 6.2 compresses the second spring plate 3.1.2, the second spring plate 3.1.2 being deformed under compression driving the free end of the second spring plate 3.1.2 to move closer to the second stationary contact 3.4; with enough force imposed on the paddle piece 2, the free end of the second spring plate 3.1.2 contacts the second stationary contact 3.4; now, the electric circuit is conducted, with a signal being produced and transmitted to the circuit board 8, actuating the height adjustable desk to move down, during which process, the first spring plate 3.1.1 does not interact with the first cantilever 6.1; when the paddle piece 2 is released, inherent elasticity of the second spring plate 3.1.2 drives the paddle piece 2 to return to its initial position; now, the electric circuit is interrupted, the signal is interrupted, and the height adjustable desk stops movement. In the technical solution described supra, the first spring plate 3.1.1 and the second spring plate 3.1.2, the first stationary contact 3.2 and the second stationary contact 3.4, and the first cantilever 6.1 and the second cantilever 6.2 are all disposed at two opposite sides of the rocker 4, respectively, such that the up/down tilt torques of the paddle piece 2 are substantially identical, which produces substantially consistent tactile and audio feedbacks for each contactor. Therefore, when the paddle-style handset control according to this disclosure is tilted, the tactile and audio feedback may maintain highly consistent, offering an improved manipulation experience.

In some examples, the switch body 3.0 further comprises a holder 3.5; the first spring plate 3.1.1 comprises a spring plate body 3.1.1.0 and a reset tab 3.8; the spring plate body 3.1.1.0 comprises a fixed end connected to the holder 3.5 and a free end where the first movable contact 3.13 is disposed; the reset tab 3.8 is arranged between the free end and the fixed end of the spring plate body 3.1.1.0, one end of the reset tab 3.8 being secured to the spring plate body 3.1.1.0, another end thereof being positioned on the holder 3.5, the reset tab 3.8 being bent in a direction opposite a deformation direction of the spring plate body 3.1.1.0; and the first cantilever 6.1 is arranged between the fixed end of the spring plate body 3.1.1.0 and the reset tab 3.8.

In the technical solution described supra, the deformation direction of the spring plate body 3.1.1.0 refers to the bent direction of the spring plate body 3.1.1.0 when being compressed by the first cantilever 6.1. The elastic force of the first spring plate 3.1.1 is jointly contributed by the spring plate body 3.1.1.0 and the reset tab 3.8; the reset tab 3.8 bent in a direction opposite the deformation direction of the spring plate body 3.1.1.0 may provide an elastic force contrary to the deformation direction of the spring plate body 3.1.1.0 to thereby increase the overall elastic force of the first spring plate 3.1.1. In the initial stage of the first cantilever 6.1 compressing the spring plate body 3.1.1.0, the restoring force provided by the reset tab 3.8 may reduce the elastic deformation of the free end of the spring plate body 3.1.1.0, giving a greater elastic support force to the first spring plate 3.1.1, which helps retain a persistent elastic support to the first spring plate 3.1.1 to thereby extend the service life of the first spring plate 3.1.1. When the first cantilever 6.1 compresses the spring plate body 3.1.1.0 to an extent exceeding a threshold value, the first spring plate 3.1.1 is quickly deformed to hit the first stationary contact 3.2, with a collision sound produced.

In some examples, when no external force is applied to the paddle piece 2, a distance from a contact point 3.9 (i.e., a first position) between the first cantilever 6.1 and the spring plate body 3.1.1.0 to the first stationary contact 3.2 is shorter than a distance from a connection point (i.e., a second position) between the reset tab 3.8 and the holder 3.5 to the first stationary contact 3.2. In the initial stage of the first cantilever 6.1 compressing the spring plate body 3.1.1.0, the distance from the connection point between the reset tab 3.8 and the spring plate body 3.1.1.0 to the second position is reduced, which increases deformation of the reset tab 3.8 and thusly increases the elastic force of the reset tab 3.8, thereby reducing elastic deformation of the free end of the spring plate body 3.1.1.0. When the first cantilever 6.1 continues compressing the spring plate body 3.1.1.0 till beyond a threshold value, with the first movable contact 3.13 moving closer to the first stationary contact 3.2, the distance from the connection point between the reset tab 3.8 and the spring plate body 3.1.1.0 to the second position increases, which reduces deformation of the reset tab 3.8 so that a return force is produced; the return force of the reset tab 3.8 may reduce the elastic force of the spring plate body 3.1.1.0, so that the first spring plate 3.1.1 hits the first stationary contact 3.2 quickly with a clear and pleasant collision sound produced.

In some examples, the fixed end of the spring plate body 3.1.1.0 and said another end of the reset tab 3.8 co-act to clamp the holder 3.5 tightly so that one end of the first spring plate 3.1.1 is snap-fitted with the holder 3.5. Two engaging slots 3.6 are provided on the holder 3.5, and a through hole 3.7 is provided on the spring plate body 3.1.1.0, one end of the holder 3.5 projecting into the corresponding through hole 3.7, one of the engaging slots 3.6 abutting tightly against an inner wall of one side of the corresponding through hole 3.7, the free end of the reset tab 3.8 being pressed tightly in the other engaging slot 3.6, whereby the reset tab 3.8 and the spring plate 3.1 co-act to produce a return force. In the technical solution described supra, the reset tab 3.8 may leverage its own elastic force to co-act with the spring plate body 3.1.1.0 to clamp the holder 3.5 tightly, thereby achieving a detachable, stable, and easily installable secure connection between the first spring plate 3.1.1 and the holder 3.5. The reset tab 3.8 may not only provide an elastic force driving return of the first spring plate 3.1.1, but also may leverage its own elastic force to secure the first spring plate 3.1.1 to the holder 3.5.

The second spring plate 3.1.2 also comprises a spring plate body 3.1.1.0 and a reset tab 3.8; two holders 3.5 are provided, one of the holders 3.5 corresponding to the second spring plate 3.1.2; the spring plate body 3.1.1.0 comprises a fixed end connected to the corresponding holder 3.5 and a free end where the second movable contact 3.14 is disposed, the reset tab 3.8 being disposed between the free end and the fixed end of the spring plate body 3.1.1.0, one end of the reset tab 3.8 being secured to the spring plate body 3.1.1.0, another end thereof being positioned on the corresponding holder 3.5, the reset tab 3.8 being bent in a direction contrary to a deformation direction of the spring plate body 3.1.1.0; and the second cantilever 6.2 is disposed between the fixed end of the spring plate body 3.1.1.0 and the reset tab 3.8. The fixed end of the spring plate body 3.1.1.0 and said another end of the reset tab 3.8 co-act to clamp the corresponding holder 3.5 tightly, whereby the one end of the second spring plate 3.1.2 is snap-fitted with the corresponding holder 3.5.

In some examples, the first movable contact 3.13 and the first stationary contact 3.2 are laminated in the thickness direction of the paddle piece 2, and the second movable contact 3.14 and the second stationary contact 3.4 are laminated in the thickness direction of the paddle piece 2.

In the technical solution described supra, the thickness direction is parallel to a rotating plane of the paddle piece 2; this setting may reduce the thickness of the paddle-style handset control, giving the paddle-piece handset control a light and thin profile.

In some examples, a rotating axis of the rocker 4 relative to the switch body 3.0 and a rotating axis of the paddle piece 2 relative to the bracket 1 are located in a same vertical plane.

A limiting slot 1.1 is provided on the bracket 1; the paddle piece 2 comprises a handle 2.1 and a limiting member 2.2 secured to the handle 2.1, one end of the limiting member 2.2 projecting in the limiting slot 1.1 so that the limiting member 2.2 is rotatable in the limiting slot 1.1 relative to the bracket 1. This structure plays a role of positioning during assembly, which facilitates quick assembly; in addition, after the assembly is completed, a rotational connection structure is created so that the paddle piece 2 can rotate relative to the bracket 1. The handle 2.1 is formed by the horizontal connecting section 2.1.1 and the manipulating section 2.1.2.

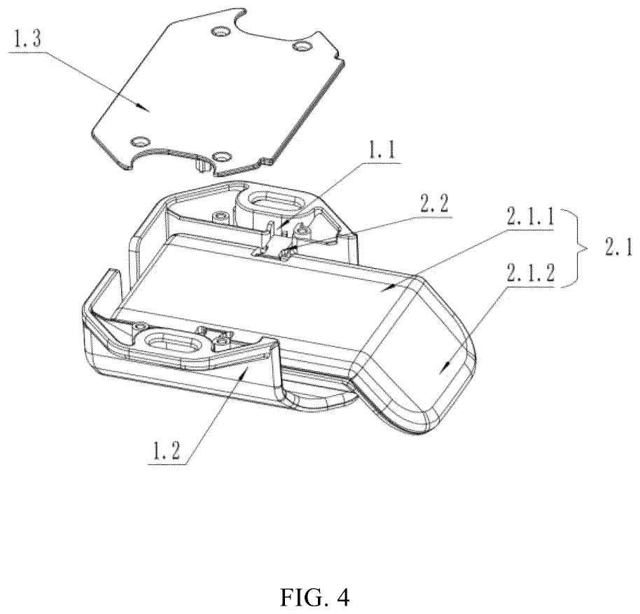

As illustrated in FIG. 4, the bracket 1 comprises a base 1.2 and a cover plate 1.3, one end of the handle 2.1 being disposed between the base 1.2 and the cover plate 1.3, another end of the handle 2.1 extending out of the bracket 1. In the technical solution described supra, by arranging said another end of the handle 2.1 to extend out of the bracket 1, user manipulation is facilitated. A first cable hole 1.4 configured for a cable to pass through is provided on the bracket 1, and a second cable hole 2.3 configured for the cable to pass through is provided on the handle 2.1.

It may be understood that, one end of the rocker may be restrained on the bracket either in a manner of directly securing the end to the bracket so that the rocker is not displaced relative to the bracket during tilting of the paddle piece, with the rotating axis of the rocker relative to the switch body coinciding with the rotating axis of the paddle piece relative to the bracket, or in a manner of providing on the bracket a limiting structure that can limit the end of the rocker from being displaced with the switch body, so that the rocker can only rock relative to the switch body.

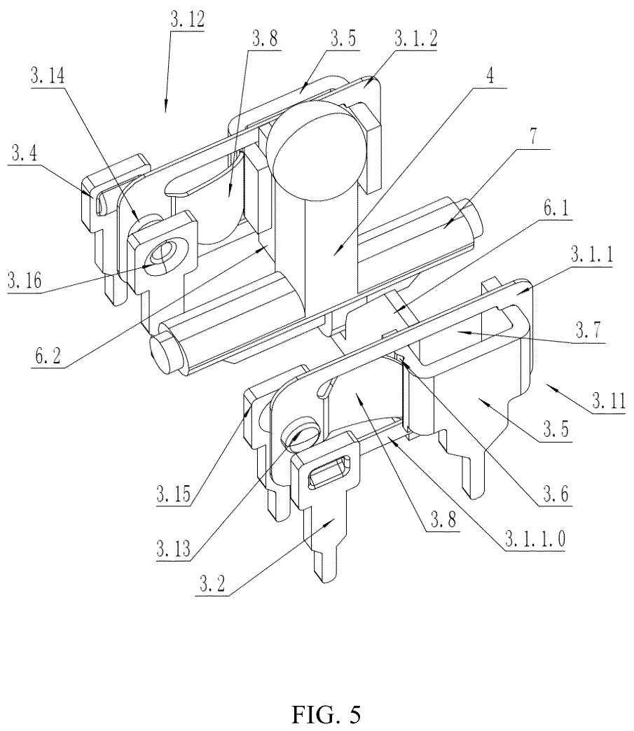

It may be understood that, in an alternative implementation, as illustrated in FIG. 5, the connection line direction between the first movable contact 3.13 and the first stationary contact 3.2 may be perpendicular to the thickness direction of the paddle piece 2. The connecting line direction between the second movable contact 3.14 and the second stationary contact 3.4 is perpendicular to the thickness direction of the paddle piece 2.

It may be understood that, in another implementation, the rotating connection structure of the paddle piece relative to the bracket may also be implemented using the technical solutions disclosed in conventional technologies CN 202010013776.2 and CN202110599770.2.

In this disclosure, a slack state of the paddle piece 2 refers to no external force being applied to the paddle piece 2.

### Second Implementation

As illustrated in FIGS. 2, 3, and 5, on the basis of the first implementation, the up contactor 3.11 further comprises a third stationary contact 3.15, and the down contactor 3.12 further comprises a fourth stationary contact 3.16, the first movable contact 3.13 being disposed between the first stationary contact 3.2 and the third stationary contact 3.15, the second movable contact 3.14 being disposed between the second stationary contact 3.4 and the fourth stationary contact 3.16; when the paddle piece 2 is tilted and then released, the first movable contact 3.13 returns to hit the third stationary contact 3.15 with a sound produced, or the second movable contact 3.14 returns to hit the fourth stationary contact 3.16 with a sound produced.

In the technical solution described supra, the collision sound produced when the first movable contact 3.13 or the second movable contact 3.14 returns plays a role of alerting, which improves user experience.

The paddle piece 2 is provided with a built-in circuit board 8, the first spring plate 3.1.1, the second spring plate 3.1.2, the first stationary contact 3.2, the second stationary contact 3.4, the third stationary contact 3.15, and the fourth stationary contact 3.16 being electrically connected to the circuit board 8, respectively.

In this technical solution described supra, the third stationary contact 3.15 and the fourth stationary contact 3.16 are electrically connected to the circuit board 8, respectively; when the paddle piece 2 is in the slack state, the circuit board 8 may detect whether the first spring plate 3.1.1 contacts the third stationary contact 3.15 and whether the second spring plate 3.1.2 contacts the fourth stationary contact 3.16. When the circuit board 8 detects that the first spring plate 3.1.1 is displaced from the third stationary contact 3.15 and the first spring plate 3.1.1 contacts the corresponding third stationary contact 3.15, it may be determined as a circumstance of operation normality, in which case the electric motor can be activated; when the electric circuit 8 detects that the first spring plate 3.1.1 does not migrate from the corresponding first stationary contact 3.2 and the first spring plate 3.1.1 contacts the corresponding first stationary contact 3.2, it may be determined as a circumstance of operation abnormality, in which case the electric motor is disabled. When the circuit board 8 detects that the second spring plate 3.1.2 is displaced from the corresponding fourth stationary contact 3.16 and the second spring plate 3.1.2 contacts the corresponding second stationary contact 3.4, it may be determined as a circumstance of operation normality, in which case the electric motor can be activated. When the electric board 8 detects that the spring plate 3.1 does not migrate from the corresponding fourth stationary contact 3.16 and the second spring plate 3.1.2 contacts the corresponding second stationary contact 3.4, it may be determined as a circumstance of operation abnormality, in which case the electric motor is disabled. Operation abnormality may also arise in the following circumstances: water gets in the paddle-style handset control, or the first stationary contact 3.2, the second stationary contact 3.4, the third stationary contact 3.15, and the fourth stationary contact 3.16 are displaced from their original positions, etc.; in such circumstances, the electric circuit 8 may issue an alarm for servicing. This technical solution may prevent accidental activation of the paddle-style handset control under abnormal circumstances and thusly prevent occurrence of accidents. In addition, the third stationary contact 3.15 and the fourth stationary contact 3.16 may serve as a limiting member and also an electric signal trigger; this multi-purpose setting simplifies the structure of the paddle-style handset control.

In some examples, a magnet is provided at the free ends of the first spring plate 3.1.1 and the second spring plate 3.1.2, respectively; the first movable contact 3.13, the second movable contact 3.14, the third stationary contact 3.15, and the fourth stationary contact 3.16 are all made of a magnetic metal; when the paddle piece 2 is tilted towards one side, the first cantilever 6.1 compresses the first spring plate 3.1.1 so that the first spring plate 3.1.1 is deformed under compression; an attracting magnetic force between the magnet on the first spring plate 3.1.1 and the corresponding third stationary contact 3.15 holds the free end of the first spring plate 3.1.1 still; when the force imposed on the first spring plate 3.1.1 due to tilting of the paddle piece 2 is greater than the attracting magnetic force between the magnet on the first spring plate 3.1.1 and the third stationary contact 3.15, the free end of the first spring plate 3.1.1 is displaced from the corresponding third stationary contact 3.15 to hit the first movable contact 3.13 with a sound being produced while maintaining contact with the first movable contact 3.13. In the initial stage of tilting and then releasing the paddle piece 2, the attracting magnetic force between the magnet on the first spring plate 3.1.1 and the corresponding first movable contact 3.13 holds the free end of the first spring plate 3.1.1 still; when the paddle piece 2 is completely released, the return force produced by the first spring plate 3.1.1 is greater than the attracting magnetic force between the magnet on the first spring plate 3.1.1 and the corresponding first movable contact 3.13, driving the free end of the first spring plate 3.1.1 to migrate from the corresponding first movable contact 3.13 to hit the third stationary contact 3.15 with a sound being produced while maintaining contact with the third stationary contact 3.15. The motion relationships between the second spring plate 3.1.2, the second movable contact 3.14, and the fourth stationary contact 3.16 are identical to the motion relationships between the first spring plate 3.1.1, the first movable contact 3.13, and the third stationary contact 3.15 as described supra.

In this technical solution, the first movable contact 3.13, the second movable contact 3.14, the third stationary contact 3.15, and the fourth stationary contact 3.16 are all made of a magnetic metal, which can be attracted by a magnet. When no external force is applied to the paddle piece 2, the attracting force between the magnet on the first movable contact 3.13 and the corresponding third stationary contact 3.15 holds the free end of the first movable contact 3.13 still with the third stationary contact 3.15 being attracted, which increases reliability of the electrical connection. When the paddle piece 2 is tilted to one side, the housing 3.3 drives the first movable contact 3.13 to compress the corresponding first cantilever 6.1 so that the first spring plate 3.1.1 is deformed under compression; however, since the compressing force is smaller than the attracting magnetic force, the free end of the first spring plate 3.1.1 holds still; when the paddle piece 2 continues being tilted so that the compressing force produced by the first cantilever 6.1 against the first spring plate 3.1.1 is greater than the attracting magnetic force between the magnet on the first spring plate 3.1.1 and the corresponding third stationary contact 3.15, the free end of the first spring plate 3.1.1 migrates from the corresponding third stationary contact 3.15 to hit the first movable contact 3.13 with a sound being produced as an alert while maintaining contact with the first movable contact 3.13; now, the magnet on the first spring plate 3.1.1 magnetically attracts the first moving contact 3.13, which increases reliability of the electrical connection. In the initial stage of releasing the handle 2.1 after the paddle piece 2 is tilted, the first cantilever 6.1 is not completely reset yet, which still applies a compression force against the first spring plate 3.1.1, and the attracting magnetic force between the magnet on the first spring plate 3.1.1 and the corresponding first movable contact 3.13 holds the free end of the first spring plate 3.1.1 still; after the paddle piece 2 is released with enough travel or is completely released so that the return force produced by the first spring plate 3.1.1 is greater than the attracting magnetic force between the magnet on the first spring plate 3.1.1 and the corresponding first movable contact 3.13, the free end of the first spring plate 3.1.1 migrates from the corresponding first movable contact 3.13 to hit the third stationary contact 3.15 with a sound being produced while maintaining contact with the third stationary contact 3.15. This technical solution allows for producing a sound when the first spring plate 3.1.1 contacts the first movable contact 3.13 and the third stationary contact 3.15, respectively, which plays a role of alerting; in addition, the attracting magnetic force may increase reliability of the electrical connection.

It may be understood that, in another implementation, the first spring plate and the second spring plate are made of a magnetic metal and can be attracted by a magnet; in addition, a copper coating is applied on their outer surfaces to increase electrical conductivity and rust-proof performance.

### Third Implementation

On the basis of the first implementation, when the paddle piece is in the slack state, one side of the first cantilever abuts tightly against the first spring plate and one side of the second cantilever abuts tightly against the second spring plate, so that the first spring plate and the second spring plate are disposed in a pre-deformed state.

In this technical solution, the first spring plate and the second spring plate in the pre-deformed state have certain elastic force that may produce certain reacting force against the first cantilever and the second cantilever, which prevents empty run of the rocker and improves tactile sensation from tilting the paddle piece. When the paddle piece is in the slack state, a gap is existent between the first movable contact and the third stationary contact; when the compressed first spring plate returns rapidly, the inertia drives the free end of the first spring plate to hit the third stationary contact with a clear and pleasant sound being produced, which plays a role of alerting; when the hit free end of the first spring plate stops movement, the first movable contact contacts the third stationary contact, which may prevent the third stationary contact from interfering with the abutment relationship between the first cantilever and the first spring plate. Due to existence of the gap between the second movable contact and the fourth stationary contact, when the compressed second spring plate returns rapidly, the inertia drives the free end of the second spring plate to hit the fourth stationary contact with a clear and pleasant sound being produced, which plays a role of alerting; when the hit free end of the second spring plate stops movement, the second movable contact contacts the fourth stationary contact, which may prevent the fourth stationary contact from interfering with the abutment relationship between the second cantilever and the second spring plate.

### Fourth Implementation

A height adjustable desk comprises a desktop support, a desktop board mounted on the desktop support, and the paddle-style handset control as described in the first, second, or third implementation described supra, the bracket of the paddle-style handset control being secured to the desktop board.

1. A paddle-style handset control, comprising a bracket and a paddle piece rotatably mounted on the bracket, the paddle piece comprising a horizontal connecting section disposed in the bracket and a manipulating section extending inclinedly downwardly out of the bracket, wherein the paddle-style handset control further comprises a two-way switch, the two-way switch comprising a switch body and a rocker, the switch body being installed on the paddle piece; the switch body comprises an up contactor and a down contactor; the rocker is provided thereon with a rotating shaft, one end of the rocker being rotatably connected to the switch body via the rotating shaft, another end thereof being restrained on the bracket; the paddle piece is tilted driving the rocker to rock relative to the switch body to thereby trigger the up contactor or the down contactor.

2. The paddle-style handset control according to claim 1, wherein the up contactor and the down contactor are disposed at two opposite sides of the rocker; and a first cantilever and a second cantilever are secured at the end of the rocker connected to the switch body, the first cantilever and the second cantilever being arranged at two opposite sides of the rocker in such a manner that the first cantilever is disposed corresponding to the up contactor, the second cantilever is disposed corresponding to the down contactor.

3. The paddle-style handset control according to claim 2, wherein the switch body further comprises a housing; the up contactor comprises a first movable contact and a first stationary contact; the down contactor comprises a second movable contact and a second stationary contact; the first stationary contact and the second stationary contact are both secured to the housing; the first cantilever drives the first movable contact to move so that the first movable contact contacts the first stationary contact; and the second cantilever drives the second movable contact to move so that the second movable contact contacts the second stationary contact.

4. The paddle-style handset control according to claim 3, wherein the up contactor further comprises a third stationary contact, and the down contactor further comprises a fourth stationary contact; the first movable contact is disposed between the first stationary contact and the third stationary contact, and the second movable contact is disposed between the second stationary contact and the fourth stationary contact; and when the paddle piece is tilted and then released, the first movable contact returns to hit the third stationary contact with a sound produced, or the second movable contact returns to hit the fourth stationary contact with a sound produced.

5. The paddle-style handset control according to claim 4, wherein the first movable contact and the first stationary contact are laminated in a thickness direction of the paddle piece, and the second movable contact and the second stationary contact are laminated in the thickness direction of the paddle piece.

6. The paddle-style handset control according to claim 4, wherein the up contactor further comprises a first spring plate, one end of the first spring plate being secured to the housing and another end thereof being free, the first movable contact being disposed at the free end of the first spring plate, the first cantilever abutting tightly against the first spring plate; the down contactor further comprises a second spring plate, one end of the second spring plate being secured to the housing and another end thereof being free, the second movable contact being disposed at the free end of the second spring plate, the second cantilever abutting tightly against the second spring plate.

7. The paddle-style handset control according to claim 6, wherein the switch body further comprises a holder; and the first spring plate comprises a spring plate body and a reset tab, the spring plate body comprising a fixed end connected to the holder and a free end where the first movable contact is disposed, the reset tab being disposed between the free end and the fixed end of the spring plate body, one end of the reset tab being secured to the spring plate body, another end of the reset tab being positioned on the holder, the reset tab being bent in a direction opposite a deformation direction of the spring plate body, the first cantilever being disposed between the fixed end of the spring plate body and the reset tab.

8. The paddle-style handset control according to claim 7, wherein the fixed end of the spring plate body and the another end of the reset tab co-act to clamp the holder tightly so that the one end of the first spring plate is detachably connected to the holder.

9. The paddle-style handset control according to claim 1, wherein a limiting slot is arranged on the bracket; the paddle piece comprises a handle and a limiting member secured to the handle, one end of the limiting member projecting into the limiting slot so that the limiting member is rotatable in the limiting slot relative to the holder.

10. A height adjustable desk, comprising a desktop support and a desktop board mounted on the desktop support, wherein the height adjustable desk further comprises a paddle-style handset control according to claim 1, a bracket of the paddle-style handset control being secured to the desktop board.
